(19) United States
(12) Patent Application Publication
(10) Pub. No.: US 2009/0016617 A1
(43) Pub. Date: Jan. 15, 2009

(54) Sender dependent messaging viewer

(75) Inventors: Orna Bregman-Amitai, Tel-Aviv (IL); Nili Karmon, Tel-Aviv (IL)

Correspondence Address: MARTIN D. MOYNIHAN d/b/a PRTSI, INC., P.O. BOX 16446, ARLINGTON, VA, 22215, US

(73) Assignee: Samsung Electronics Co., Ltd., Gyeonggi-do (KR)

(21) Appl. No.: 11/826,314

(22) Filed: Jul. 13, 2007

(51) Int. Cl. G06K 9/72

(52) U.S. Cl. 382/229

(57) ABSTRACT

A mobile apparatus for receiving an electronic message that comprises a text message from a sender. The mobile device comprises a contact records repository that stores a number digital images, which are associated with a respective number of user identifiers. The mobile device further comprises a text analysis module that identifies predefined expressions in the text message, an image-editing module that matches one of the user identifiers with the sender and edits the associated digital image according to the identified predefined expression, and an output module for outputting the edited digital image.

### FIELD AND BACKGROUND OF THE INVENTION

The present invention relates to a method and an apparatus for receiving and displaying electronic messages and, more particularly, but not exclusively to a method and a portable apparatus for receiving and displaying electronic messages.

One of the most popular communication technologies that have been developed for mobile communications systems is text messaging. Text messaging services allow communication that is based on typed text between two or more mobile users.

The most common communication that provides such a service is the short message service (SMS). The SMS allows mobile users to receive text messages via wireless communication devices, including SMS-capable cellular mobile phones. Mobile and stationary users may send an electronic message by entering text and a destination address of a recipient user who is either a mobile or a non-mobile user.

Another example for such a communication service is a mobile instant messaging (MIM) service. The MIM service allows real-time communication that is based on typed text between two or more mobile users. The text is conveyed via one or more cellular networks.

Generally, an emoticon is represented in a text format by combining the characters of a keyboard or keypad. Recent developments have been designed with the ability to allow the inclusion of icons indicative of emotions, which may referred to as emoticons, into the text. Such emoticons may include a smiling figure, a frowning figure, a laughing figure or a crying figure, a figure with outstretched arms and other figures expressing various feelings. A graphic emoticon is transmitted to a mobile communication terminal by first selecting one of the graphic emoticons, which are stored in a user's mobile communication terminal as image data. Subsequently, the selected graphic emoticon is transmitted to another mobile communication terminal using a wireless data service.

For example, U.S. Patent Application No. 2007/0101005, published May 3, 2007, discloses an apparatus and method for transmitting emoticons in mobile communication terminals. The apparatus and the method include receiving a transmission request message in a first mobile communication terminal, the transmission request message related to a first graphic emoticon and including identification information for the first graphic emoticon, identifying a second graphic emoticon according to the transmission request message, and transmitting the second graphic emoticon to a second mobile communication terminal, wherein the second graphic emoticon comprises image data in a format decodable by the second mobile communication terminal.

In addition, during the last years, standards have been introduced for services including multimedia message services (MMSs) and enhanced message services (EMSs), which are standards for a telephony messaging systems that allow sending messages with multimedia objects, such as images, audio, video, rich text etc., have become very common. The MMS and EMS allow the message sender to send an entertaining message that includes an image or a video that visually expresses his or her feelings or thoughts and visually presents a certain subject matter.

A number of developments have been designed to provide services using the MMS and EMS standards. For example, U.S. Patent Application No. 2004/0121818, published Jun. 24, 2004 discloses a system, an apparatus and a method for providing MMS ringing images on mobile calls. In one embodiment, a ringing image comprises a combination of sound and images/video with optional textual information and a presentation format. The method includes receiving an incoming call from an originating mobile station; receiving an MMS message associated with the incoming call that contains ringing image data including image data and ring tone data, presenting the ringing image data to a user of the terminating mobile station, and in response to presentation of the ringing image data, receiving an indication from the user to answer the incoming call.

Though such services improve the user experience of receiving electronic messages, they require adjusted devices and additional network capabilities. In addition, more bandwidth, which is needed in order to send such electronic messages, and more computational complexity, which is needed for rendering it, are required for sending and displaying an MMS rather than a plain SMS. Moreover, these services do not inter-operate with existing SMS services in a seamless manner.

In view of the foregoing discussion, there is a need for a system that can overcome the drawbacks of these new services and provide new advanced capabilities.

### SUMMARY OF THE INVENTION

According to one aspect of the present invention there is provided a mobile apparatus for receiving an electronic message including a text message from a sender. The mobile device comprises a contact records repository that comprises a plurality of user identifiers, one or more of the user identifiers is associated with a digital image. The mobile device further comprises a text analysis module configured for identifying predefined expressions in the received text message, an image-editing module configured for matching one of the user identifiers with the sender and editing the associated digital image to correspond with the identified predefined expression, and an output module configured for outputting the edited digital image.

According to another aspect of the present invention there is provided a method for editing an electronic message comprising a text message. The method comprises a) receiving the electronic message from a sender via a wireless network, b) matching the sender with one of a plurality of user identifiers, each the user identifier being associated with a digital image, c) identifying a predefined expression in the text message, and d) editing at least one of the digital images to accord with the predefined expression, the at least one edited digital image being associated with the matched user identifier.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and the apparatus of the present invention involves performing or completing certain selected tasks or steps manually, automatically, or a combination thereof. Moreover, according to actual A instrumentation and equipment of preferred embodiments of the method and the apparatus of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and the apparatus of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustration of a device for receiving an electronic message and displaying a digital image in response, a network, and a sender, according to a preferred embodiment of present invention;

FIG. 2 is a schematic illustration of a 2D generic mask that represents a perfect face and designed to be positioned over a face area in a digital image, according to an embodiment of the present invention;

FIGS. 3A-3B and FIGS. 4A-4B are schematic illustrations of displays of an exemplary cellular phone that presents a digital image and a text message, according to an embodiment of the present invention;

FIGS. 3C and 4C and FIGS. 3D and 4D are schematic illustrations of a mask, as depicted in FIG. 2, according to which the digital images in FIGS. 3A and 4A and FIGS. 3B and 4B are respectively manipulated, according to an embodiment of the present invention;

FIG. 5 is a schematic illustration of an exemplary set of graphical objects, according to an embodiment of the present invention;

FIGS. 6A and 6B are displays of cellular phones that present a digital image and the exemplary set of graphical objects, which is depicted in FIG. 5, according to an embodiment of the present invention;

FIGS. 7A and 7B are schematic illustrations of displays of cellular phones that present a digital image with background manipulation, according to an embodiment of the present invention;

FIG. 8 is a flowchart of a method for displaying an electronic message that includes a text message, according to one embodiment of the present invention;

FIG. 9 is a flowchart of the process for editing a digital image that is associated with the sender of an electronic message, according to one embodiment of the present invention;

FIG. 10 is a table that includes exemplary predefined expressions, each associated with a different set of editing instructions, according to one embodiment of the present invention; and

FIG. 11 is a schematic illustration of a display of a cellular phone that presents a digital image and a callout that includes that text of the electronic message, according to an embodiment of the present invention.

### DESCRIPTION OF THE PREFERRED EMBODIMENTS

The present embodiments comprise a mobile apparatus, such as a cellular phone, for receiving electronic messages, such as SMSs and IMs, from a sender that is connected to a network, such as a cellular or a computer network. The mobile apparatus comprises a receiving module for receiving the electronic message and a contact records repository with a number of user identifiers, each associated with a digital image that preferably depicts the face of a related contact person and a background. Optionally, the mobile apparatus is a cellular phone and the user identifiers are members of the contact list or address book thereof. The mobile apparatus further comprises a text analysis module and an image-editing module. In use, when the receiving module receives an electronic message from a sender, it forwards the electronic message to the text analysis module that analyzes the electronic message and matches one of the user identifiers with the sender. Then, the image-editing module edits the matched digital image according to an analysis of the text in the received message. The edited and matched digital image may now be displayed together with or instead of the text in the message. In such a manner, when a certain sender send an electronic message to mobile apparatus, his or her face, which is depicted in the matched digital image, the background, or both, may be edited to reflect the content of the text in his or her message. Such an embodiment provides a more vivid experience to the user of the mobile device. For example, a message comprising a text may be presented in association with an edited version of the digital image of the sender that is animated to reflect his or her sadness. An edited digital image may be understood as a manipulated digital image, animated digital image, and a digital image with added graphical objects, a sequence of edited digital images, or any combination of these digital images. Editing a digital image may be understood as animating the digital image, manipulating the digital image, generating a sequence of digital images, adding graphical objects to the digital image, or any combination of the these actions.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. In addition, it is to be understood that the phraseology and terminology employed herein is for the purpose of description and should not be regarded as limiting.

A network may be understood as a cellular network, a computer network, a wireless IP-based network, a WLAN, or the combination thereof.

A sender may be understood as a mobile phone, a dual-mode phone, a personal digital assistant (PDA), or any other system or facility that is capable of providing information transfer between persons and equipment.

An electronic message may be understood as an SMS, an MIM, an email, or any other message that comprises an analyzable message.

A mobile device may be understood as a mobile phone, a dual-mode phone, a personal digital assistant (PDA), or any other portable device or facility that is capable of receiving electronic messages.

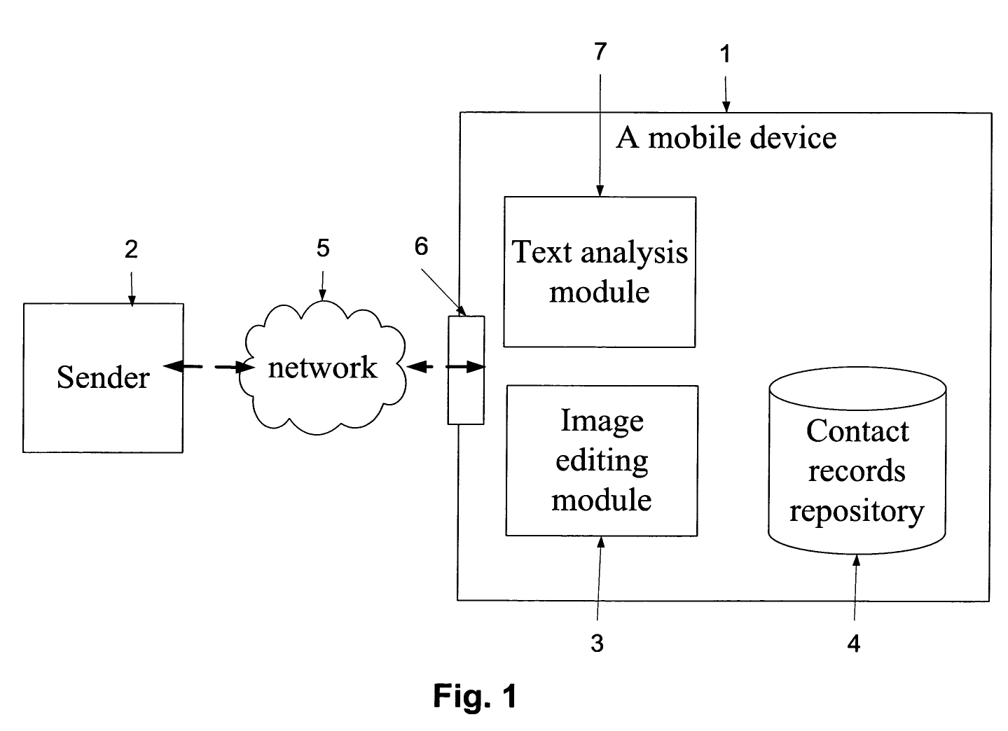

Reference is now made to FIG. 1, which is a schematic illustration of a mobile device 1 for receiving an electronic message, a network 5, and a sender 2, according to an embodiment of the present invention. The mobile device 1 comprises a receiving module 6 for receiving electronic messages via the network 5, a contact records repository 4, an image-editing module 3, and a text analysis module 7. Optionally, the mobile device 1 is a cellular phone, the network 5 is a cellular network, and the electronic message is an SMS or an MIM. The contact records repository 4 comprises a number of digital images of a number of contact persons. Preferably, each digital image comprises an area that depicts the face of the contact person, and may be referred to as the face area. It should be noted that a digital image may be understood as a still image, a sequence of images, a 2D avatar, a 3D avatar, a graphical object, etc.

The text analysis module 7 is designed to identify predefined expressions, such as words, terms, sentences, and emoticons in the text message. Optionally, text analysis module 7 is designed to identify predefined expressions such as a certain font. Each one of the predefined expressions is associated with a set of instructions, which is designed to animate or manipulate a digital image that depicts a figure in a manner that the figure, the background of the figure, or both visually express the predefined expressions, preferably as describe below.

As described above, the contact records repository 4 comprises a number of digital images of a number of contact persons. In one embodiment of the present invention, the contact records repository 4 is the contact list of the mobile device 1. Each one of the digital images is associated with a user identifier such as a network user ID, for example a phone number or a subscriber ID. In such a manner, the user of the mobile device 1 may be able to upload a digital image that is, in the mind of the contact list owner, closely related to the contact person who has the network user ID. In one embodiment of the present invention, each one of the network user IDs in the contact list is associated with a digital image, a sequence of digital images, such as a video file or both.

As commonly known, each electronic message includes a network user ID that indicates the address of the sender. The text analysis module 7 uses the network user ID of the sender to identify a digital image that is associated with a respective network user ID in the contact records repository 4. The identified digital image, which may be referred to as the matching digital image, preferably depicts the face of the sender.

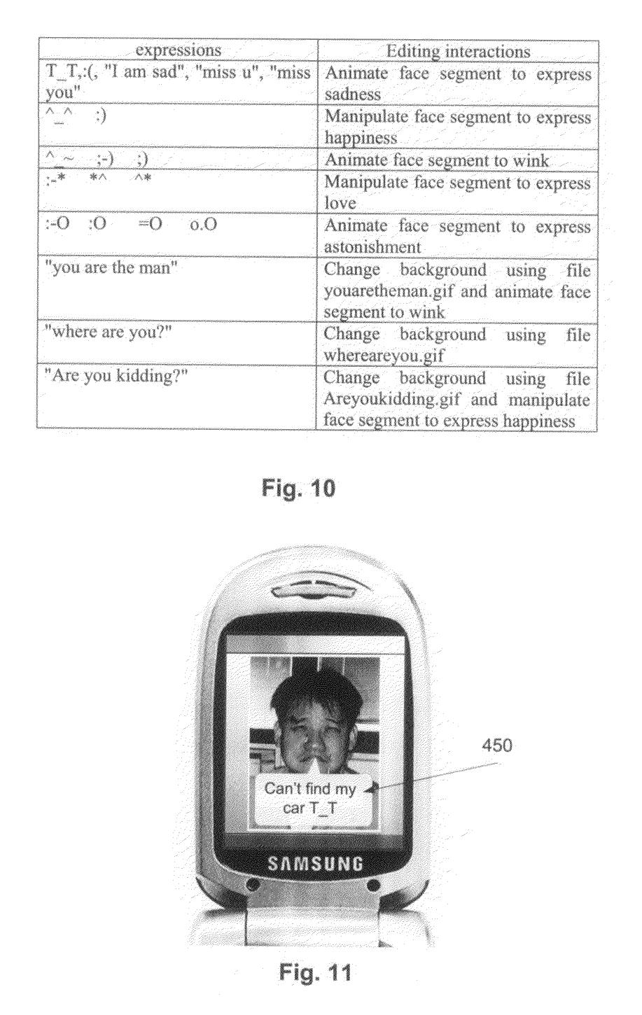

In particular, the electronic message may be an SMS, an MIM, or any other type of electronic message that comprises an analyzable message. As commonly known, the SMS—point-to-point (SMS-PP) and the SMS—Cell Broadcast (SMS-CB) protocols, which are defined respectively in the GSM 03.40 and GSM 03.41 recommendations, which are disclosed herein by reference, define the protocols for allowing electronic text messages to be transmitted to a mobile device in a specified geographical area. A transmission of SMSs may be done via different protocols, such as signaling system No. 7 (SS7) that is incorporated by herein by reference, within the standard GSM MAP framework or transmission control protocol internet protocol (TCP/IP) within the same standard. Messages are sent with the additional MAP operation forward_short_message that is limited by the constraints of the signaling protocol to precisely 140 bytes. Characters in languages such as Arabic, Chinese, Korean, Japanese or Slavic languages are encoded using the 16-bit UCS-2 character encoding. Each electronic message includes a text that comprises a number of characters, such as letters, numbers, symbols, and emoticons. The text analysis module 7 is designed to analyze the characters in the text message and to identify predefined letters or strings therein. Optionally, the text analysis module 7 is designed to identify predefined emoticons in the text message. Optionally, the text analysis module 7 is designed to identify certain terms, words, or sentences in the text message. The identification may be a straightforward identification that is based on a matching table, as described below with reference to FIG. 10 or using text analysis methods. To analyze the text message, the text therein is generally converted to numerical or categorical data. As used in this document, “text” may refer to any combination of alphanumeric characters. It may also include punctuation marks, database records and/or symbols that have a meaningful relationship to each other.

As described above, the image-editing module 3 is designed to animate or to manipulate the digital image that is associated with the respective network user ID. Optionally, the image-editing module 3 animates a face area in the digital image that depicts the face of the sender. In such an embodiment, the image-editing module 3 delimits the face area before it is animated, as further described below. Optionally, the animation or manipulation is defined using a face mask, such as a basic generic mask, for example a two dimensional (2D) generic mask or a three dimensional (3D) generic mask. In use, the basic generic mask is positioned over a face area that is identified in the matching digital image.

Optionally, the image-editing module 3 is designed to apply lip movement on the face in the associated digital image according to one or more of the identified predefined expressions within the text messages. In such a manner, the figure in the digital image may be animated to express the identified predefined expressions. For example, the figure in the digital image may be given a lip movement that stands for a certain facial expression, such as a smile, or with a set of lip movements that animates the figure in the digital image to look as though he or she is saying the identified predefined expressions.

Optionally, the image-editing module 3 is designed to apply graphic effects, object animation, 2D and 3D animations to predefined objects, and 2D and 3D image manipulations, which are associated with the sender.

Optionally, such a sender dependent animation is based on the network ID number of the sender. For example, animating a different background to a sender that calls using a public switched telephone network (PSTN) and a different background to a sender that calls using a cellular network. In another example, a different animation is provided according to the area dialing code of the sender. Optionally, such a sender dependent animation is based on the analysis of information that is stored in the contact list of the mobile device 1 or associated with his or her user identifier.

For example, the animation is determined according to the caller group of the sender. Optionally, such a sender dependent animation is based on the time the electronic message has been received. Animation may also be understood as sound effects, such as voice clips and sound effects, which are taken from a designated sound effect library. Optionally, the animation is changed on a random basis, in a manner that the same electronic message from the same sender may be animated differently according to a deterministic or a random rule.

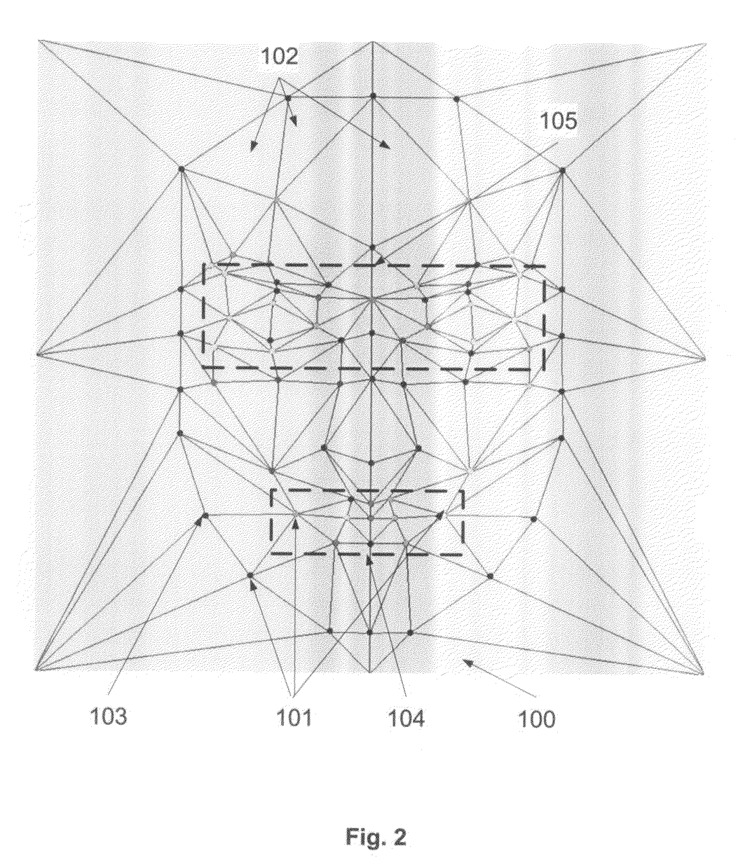

Reference is now made to FIG. 2, which is a schematic illustration of a 2D generic mask 100 that represents an archetypal face designed to be positioned over the face area in the matching digital image, according to an embodiment of the present invention. As described above, the face area may be edited according to the analysis of the text of an electronic message that is received from a sender having respective network user ID. The generic mask 100 comprises a number of vertexes 101 that define a number of triangles 102, for example 78 vertexes that define 134 triangles. A group of vertexes, for example as shown at 103, defines the boundaries of face and may be referred to as boundary vertexes. In one embodiment, such a group comprises 20 vertexes. Preferably, the boundary vertexes are designed to be static. In such an embodiment, the image manipulation is defined by changing the location of vertexes, which are defined within the boundaries of face, at key frames.

In order to allow the manipulation of the face area using the generic mask 100, the face area has to be identified in the digital image. Optionally, the device further comprises a face detection module that detects the face area within the boundaries of the digital image. The face area delimits the face that is depicted in the digital image. face area Preferably, in order to support the delimitation of the face area, the contrast between the face area and the rest of the image is sharpened.

Preferably, the HSV color space may be helpful for identifying the area of the digital image where the face is found. The delimitation of the face area is based on color information of the color pixels of the digital image. It has become apparent from statistical analysis of large data sets that the hue distribution of human skin is in a certain range. Such a range thus provides a common hue level that can be used to identify those color pixels that represent human skin. The common hue level may thus be used to detect a cluster of color pixels that represents the skin of the face in the digital image.

Preferably, the saturation level of each pixel may be used in addition to the hue level in order to augment the determination of whether the pixel represents human skin or not. Optionally, the used hue level is in a range determined in relation to a shifted Hue space. The delimitation of the face area is preferably performed once, optionally when the digital image is uploaded to the contact records repository. As the boundaries of the face are set only once, such an embodiment reduces the computational complexity of the editing of the digital image.

After the face area has been detected, a movement vector that comprises a rotation value, an x-scale value and a y-scale value, is identified according to a transformation from the generic mask to the face area. Optionally, the transformation is generalized, for example to provide a projection transformation such as one that allows face pan.

The movement vector is used to match between the vertexes 101 and respective pixels or sub-pixels on the face in the digital image. After the vertexes have been matched, the generic mask 100 may be used to manipulate the face area in the digital image. As depicted in FIG. 2, coarse triangle mesh is used to divide the face into different triangles that may be maneuvered separately when the image is edited, as described below. The coarse triangle mesh is preferably adjusted to the face as described in K. Kähler, J. Haber, and H.-P. Seidel: Dynamically refining animated triangle meshes for rendering, The Visual Computer, 19(5), pp. 310-318, August 2003, which is incorporated herein by reference and in the following URLs http://goldennumber.net/beauty.htm and http://mrl.nyu.edu/˜perlin/experiments/facedemo, which are also incorporated herein by reference. Optionally, the mesh is defined and manipulated using a graphic module that is based on one or other of the OpenGL-ES 1.0, 1.5, and 2.0 specifications, which are incorporated herein by reference.

As described above, one or more of the digital images may be avatars or graphical objects. In such an embodiment, the face area is not delimited, the mask is preferably not correlated to the depicted face, and the animation is performed according to a set of instructions that animates the depicted figure according to predefined parameters.

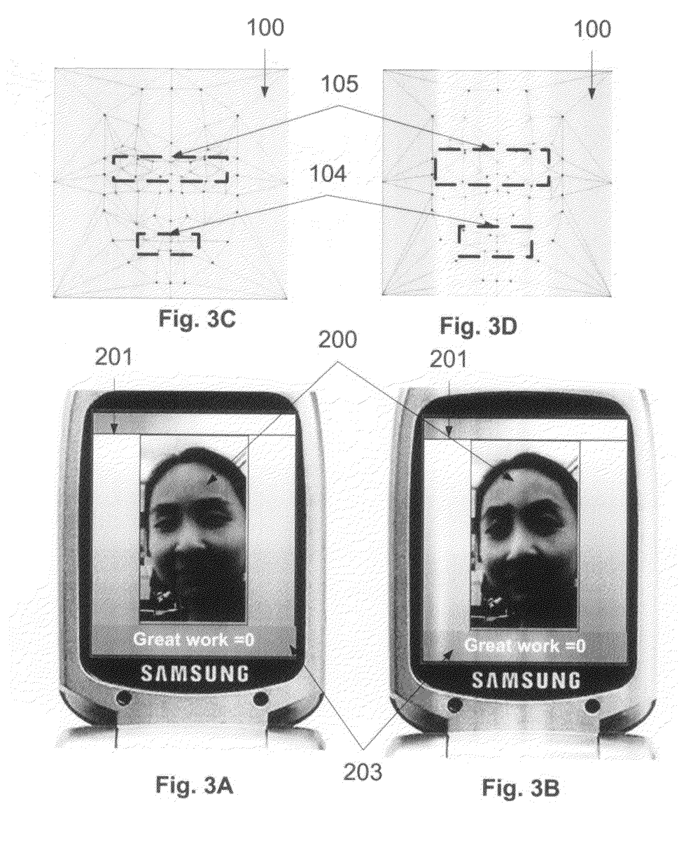

Reference is now made to FIGS. 3A and 3B, which are schematic illustrations of a display 200 of an exemplary cellular phone 201 that presents the matching digital image and the text message in the received electronic message, according to embodiments of the present invention. Reference is also made to FIGS. 3C and 3D, which are respectively schematic illustrations of the 2D generic masks 100, which are manipulated using the aforementioned image-editing module.

Clearly, as described above, the depicted cellular phone 201 is a nonbinding example of a mobile device and other mobile devices may be used. FIG. 3C depicts the mask 100 before it has been manipulated by the image-editing module. FIG. 3A depicts the digital image, which is based on the mask 100 in FIG. 3C. FIG. 3D depicts the mask 100 after the image-editing module has manipulated it. FIG. 3B depicts the digital image, which is based on the mask 100 in FIG. 3D. As depicted in FIG. 3B, the manipulation is adjusted to the content of the received text 202 that is displayed together with the digital image. The manipulation has been performed according to a text message that comprises the sign “:o” that stands for a cry of amazement and has animated the face in the digital image to express amazement.

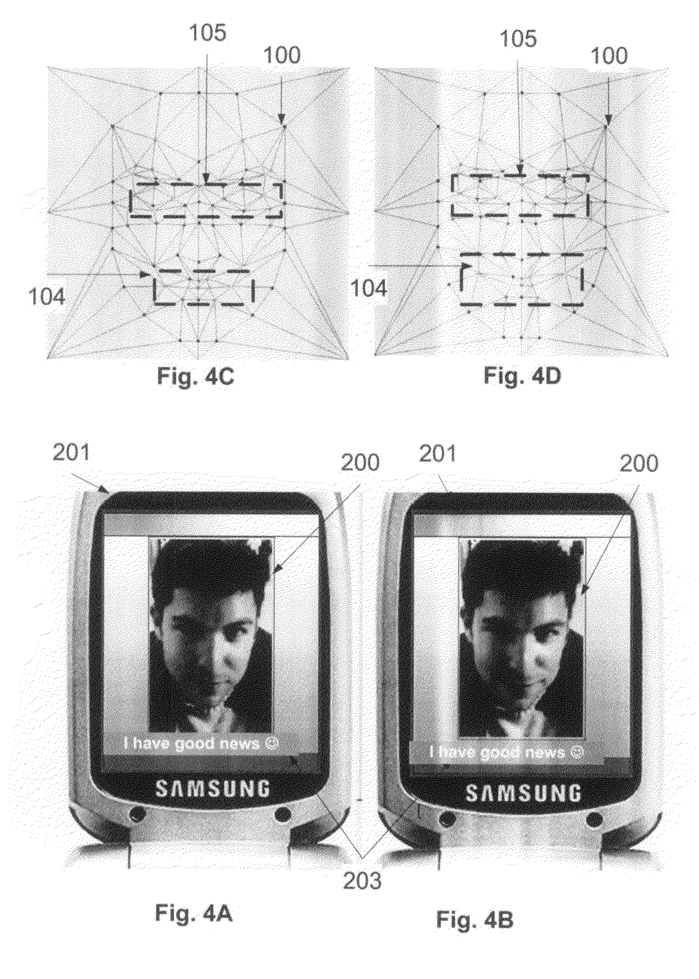

Another example of image manipulation, which is done on another matching digital image, is provided in FIGS. 4A and 4B and respectively in FIGS. 4C and 4D. FIG. 4A, which are schematic illustrations of the display 200 of the exemplary cellular phone 201 as depicts in FIG. 3A. In FIG. 4A, the display 200 presents the digital image before it has been manipulated by the image-editing module. FIG. 4C depicts the respective mask 100 before the image-editing module has manipulated it. FIG. 4D however depicts the respective mask 100 after the image-editing module has manipulated it. FIG. 4B depicts a display 200 presents a digital image that is manipulated according to the mask in FIG. 4D. The image manipulation has been performed according to a text message that comprises the emoticon [symbol] and animates the face in the digital image in a manner that allows it to express happiness.

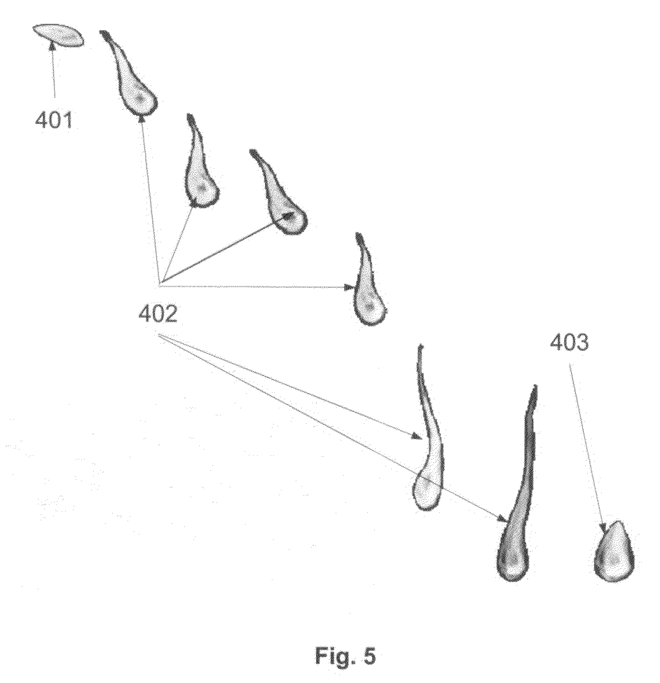

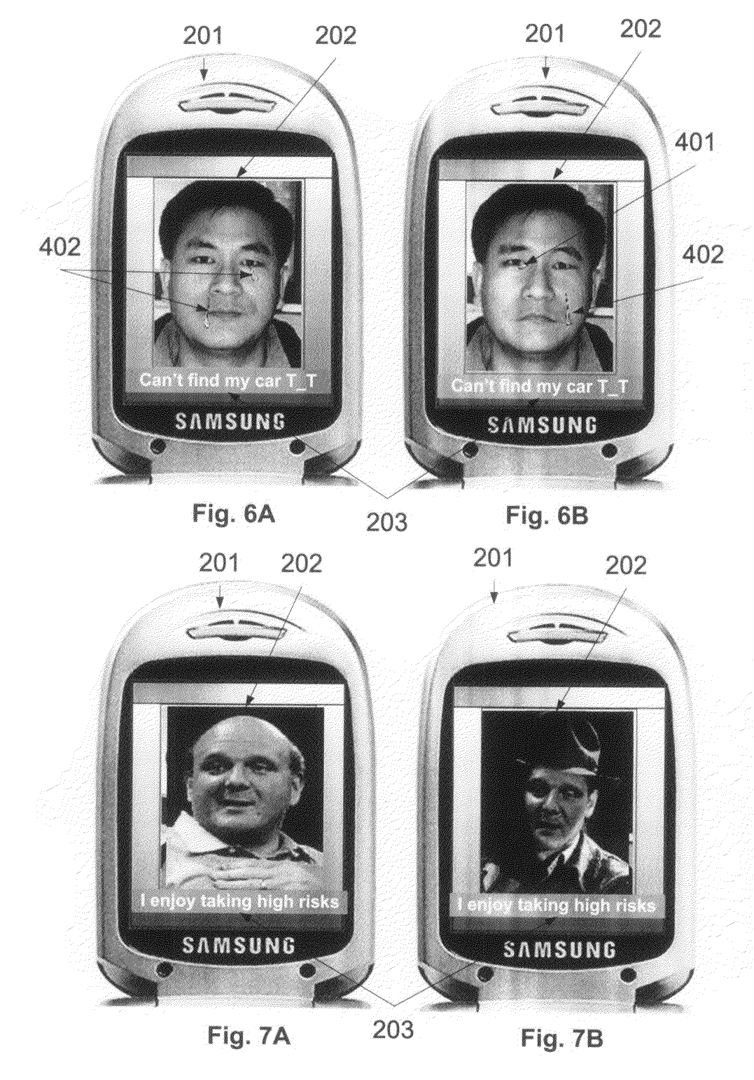

Reference is now made jointly to FIG. 5 and to FIGS. 6A and 6B. FIG. 5 is a schematic illustration of an exemplary set of graphical objects 401, 402, and 403 representing teardrops, according to an embodiment of the present invention. The exemplary set of graphical objects 401, 402, and 403 and preferably, other graphical objects are stored in the memory of the mobile device. FIGS. 6A and 6B are schematic illustrations of displays of cellular phones, as depicted in FIG. 3A, according to an embodiment of the present invention. In FIGS. 6A and 6B, the display 200 presents digital images, which are edited using the exemplary set of graphical objects 401, 402, and 403.

Optionally, the editing of the digital image is performed by adding graphical objects, as shown at 401, 402, and 403 to predefined points in the digital image, according to a set of instructions that is associated with one or more predefined expressions in the received electronic message. Each one of the graphical objects may comprise a texture that is preferably placed in a predefined position in relation to the face in the image. Optionally, the graphic objects are positioned in a predefined position on the generic mask or at a predefined distance therefrom. Optionally, one or more graphical objects are displayed sequentially, for example in a cyclical manner. For example, as shown in FIGS. 6A and 6B, the teardrops, which are shown at 401, 402, and 403, may be presented on after the other, animating the figure, which is depicted in the digital image, to look like he or she is crying.

Optionally, the editing of the digital image is performed by changing the background of the digital image. As described above, the face area area is detected and delimited either in a preprocessing step or during the process of receiving a related electronic message. In such an embodiment, one or more backgrounds are associated with different characters, emoticons, numbers or symbols that may appear in the text of the electronic message. For example, FIGS. 7A and 7B, which are schematic illustrations of the display 200 of the exemplary cellular phone 201 as in FIG. 3A, depict such an image manipulation. In FIG. 7A, the display 200 represents a digital image of the contact person that corresponds to the network user ID in a received electronic message. In FIG. 7B, the display 200 presents a manipulated version of the digital image that has been generated according to an electronic message that comprises the term “high risk”. The same image manipulation may be performed when an electronic message that includes the emoticon “:-” that stands for a male or the word “adventure” is received. Optionally, the image-editing module performs both the background editing and the aforementioned face area editing in response to the received electronic message. In such an embodiment, the face area is edited according to one set of instructions that is associated with a certain predefined expression in the text in the received electronic message, and the background is edited according to another set of instructions that is associated with another predefined expression in the text.

Reference is now made, once again, to FIG. 2.

Optionally, in order to improve the performance of the editing, the differences between the generic mask 100 and each one of the different faces may be compensated. In one embodiment of the present invention, the vertexes are divided into a number of groups. Optionally, the mesh 100 is divided into a group of 20 vertexes that defines the boundaries of the face 101, a group that defines the mouth area 104, and a group that defines the eyes area 105. The movements of the vertexes in the mouth area group are scaled in the x direction by the mouth length, and in the y direction by the distance between the eyes and the mouth. The movements of the vertexes in the eyes area group are scaled in the x direction and the y direction by the distance between the eyes. For all other vertexes, the movement is scaled by the distance between the eyes in x direction, and a distance between the eyes and the mouth in y direction. Optionally, the eye closing animation is limited in order to avoid overlapping between the upper and the lower parts.

As described above, the generic mask is used for editing the digital image of the contact person that corresponds to the received electronic message according to the text message thereof. In order to allow the generation of the edited digital image, a certain digital image has to be matched and the vertexes of the generic mask maybe correlated with pixels or sub-pixels in the digital image, as described above. Preferably, the edited digital image is presented with the text of the electronic message to the user of the mobile device. Optionally, if no digital image has been matched a default digital image is edited by the image-editing module. Likewise, if an image is available but the vertexes of the mask have not been successfully correlated with pixels or sub-pixels of the matching digital image, or for any other reason the image cannot be used, then such a default image can be used instead.

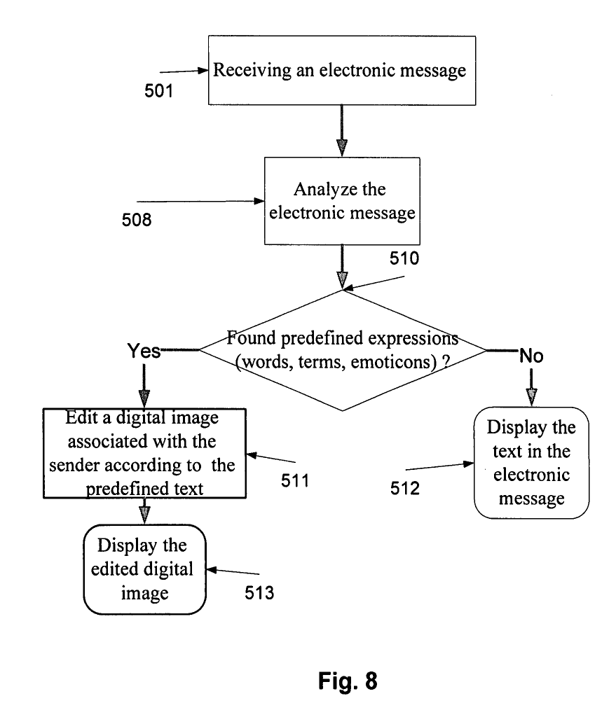

Reference is now made to FIG. 8, which is a flowchart that depicts a method for displaying an electronic message that includes a text message, according to one embodiment of the present invention. As described above and shown at 501, the mobile device, which is optionally a cellular phone or a personal computer, is designed to receive an electronic message that includes a text message that comprises a number of characters, such as an SMS or an MIM.

After the electronic message is received, the text message is analyzed, as shown at 508. As described above, one or more predefined expressions such as text sections, words, terms, sentences, or emoticons are defined and stored, preferably in the memory of the mobile device.

Optionally, a data structure, such as a lookup table (LUT) is used for storing a list of predefined expressions in association with image editing instructions. An exemplary LUT is depicted in FIG. 10. During the analysis, as shown at 510, the text in the received electronic message is searched for the predefined expressions, which are stored in the LUT. As shown at 512, if no predefined expressions are found in the received electronic message, the text is display as a regular electronic message. However, if one or more predefined expressions are found in the text, as shown at 511, the related editing instructions are used for editing the digital image that is associated with the sender.

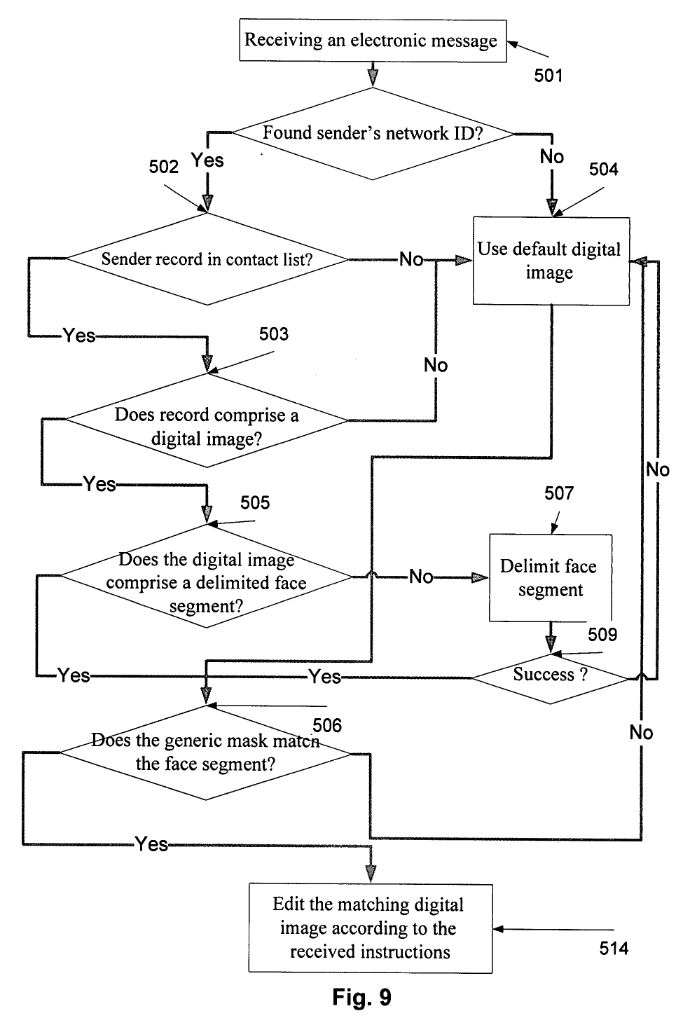

Reference is now made to FIG. 9, which is a flowchart of the process for editing the digital image that is associated with the sender, according to one embodiment of the present invention. As described above and shown at 501, the mobile device receives an electronic message. The electronic message preferably comprises the sender's network ID that is preferably a telephone number, an email address, or a subscriber ID, as described above. If the electronic message does not comprise a subscriber ID or comprises a default subscriber ID, a default digital image is chosen for editing, as shown at 504. The sender's network ID is extracted from the message by a receiving module. As shown at 502, the records of the contact list are searched for a record that matches with the sender's network ID of the sender. If a record with a matching network user ID is found, a digital image that is associated with the record is identified, as shown at 503. As described above, the associated digital image preferably includes a face area that depicts the face of the caller. If no record is matched or if the matched record is not associated with a digital image, a default digital image is chosen, as shown at 504. During the following step, as shown at 505, the terminal user verifies whether the face area of the matched digital image is segmented or not. Preferably, the face area in each one of the digital images, which are associated with records of the contact list, is segmented in a preprocessing step, for example, when a new digital image is uploaded and associated with one of the records of the contact list. The segment that comprises the face area is stored in association with the related digital image. If the face area has not been delimited, the aforementioned delimitation process is applied, as shown at 507. As shown at 509, if the delimitation fails, the default image is chosen and used. However, if the delimitation succeeds, the aforementioned generic mask is applied to the delimited face area, as shown at 505. It should be noted that if the face area has been delimited and stored in advance, the aforementioned generic mask is applied to stored delimited face area, as shown at 506. If the generic mask fails to apply to the delimited face area, the default image is used. However, if the generic mask applies to the delimited segment, the face area can be edited according to the related editing instructions, as shown at 514. As shown at FIG. 10, the related editing instructions may be used for instructing the image-editing module to edit both the background and the face area. The matched digital image is edited according to each one of the predefined expressions, which are found in the received electronic message. Optionally, each one of the predefined expressions is attached with a priority level. In such a manner, the editing is performed according to the predefined expressions with the highest priority. In one example, the received electronic message comprises the emoticon [symbol] and the word happy, which are both associated with editing instructions for manipulating the face area. The emoticon [symbol] is associated with editing instructions for manipulating the face area to express sadness and with a priority level “8”. The word happy, on the other hand, is associated with editing instructions for manipulating the face area to express happiness and with the priority level “9”. In such an embodiment, the image-editing module only manipulate the face area to express happiness according to the word happy. Optionally, the editing instructions are executed according to the order of appearance of the predefined expressions in the electronic message.

Reference is now made, once again, to FIG. 8.

After the associated digital image has been edited, as described above with reference to FIG. 9, it is displayed to the recipient on his mobile device. Optionally, the mobile device is a cellular phone and the edited digital image is presented in a designated graphical user interface (GUI), such as the MIM service GUI, on the cellular device display. Preferably, the text is presented in a callout together with the edited digital image, for example as shown at 450 in FIG. 11. As described above, the edited digital image is preferably animated.

It is expected that during the life of this patent many relevant devices and systems will be developed and the scope of the terms herein, particularly of the terms cellular phone, mobile device, electronic message, text message, and SMS are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A mobile apparatus for receiving an electronic message including a text message from a sender, the mobile device comprising:
a contact records repository comprising a plurality of user identifiers, at least one of said user identifiers being associated with a digital image;
a text analysis module configured for identifying predefined expressions in the received text message;
an image-editing module configured for matching one of said user identifiers with the sender and editing said associated digital image to correspond with said identified predefined expression; and
an output module configured for outputting said edited digital image.

2. The mobile apparatus of claim 1, wherein said digital image comprises a face area, said editing comprising editing said face area to correspond with said identified predefined expression.

3. The mobile apparatus of claim 2, wherein said identified predefined expression is associated with an emotion, said image-editing module being configured for editing said face area to express said emotion.

4. The mobile apparatus of claim 1, wherein said editing comprises generating an animated version of said associated digital image.

5. The mobile apparatus of claim 1, further comprising a face delimitation module for delimiting a face area in each said digital image, said image-editing module being configured for editing said face area to correspond to said identified predefined expression.

6. The mobile apparatus of claim 5, wherein said image editing module is configured to edit said face area using a face mask.

7. The mobile apparatus of claim 1, wherein said predefined expression comprises a member of the following group: a character, a symbol, a word, a term, a paragraph, a sign, an emoticon, and a font style.

8. The mobile apparatus of claim 1, wherein said mobile device is a cellular phone.

9. The mobile apparatus of claim 1, wherein said electronic message comprises a member of the following group: a short message service (SMS), a mobile instant messaging (MIM) service message, a multimedia message service (MMS), and enhanced message service (EMS).

10. The mobile apparatus of claim 1, wherein at least one of said plurality of user identifiers comprises a member of the following group: a telephone number, a network ID identifier, and a subscriber name.

11. The mobile apparatus of claim 2, wherein said identified predefined expression comprises at least one word, said editing comprising a step of animating the lips in said face area to match lips saying said words.

12. The mobile apparatus of claim 1, wherein said digital image depicts an avatar.

13. The mobile apparatus of claim 1, wherein said mobile apparatus stores a default digital image, said editing comprises animating said default digital image according to said identified predefined expression if said matching fails.

14. A method for editing an electronic message comprising a text message, the method comprising:
a) receiving the electronic message from a sender via a wireless network;
b) matching said sender with one of a plurality of user identifiers, each said user identifier being associated with a digital image;
c) identifying a predefined expression in the text message; and
d) editing at least one of said digital images to accord with said predefined expression, said at least one edited digital image being associated with said matched user identifier.

15. The method of claim 14, further comprises a step of displaying said edited digital image.

16. The method of claim 14, wherein said displaying comprises a step of displaying said text message.

17. The method of claim 14, said editing comprising a step of editing a face area of said associated digital image according to said predefined expression.

18. The method of claim 17, wherein at least one of said digital images comprises a face area, further comprising a preprocessing step before step d) of delimiting each said face area.

19. The method of claim 17, further comprises a step of correlating a face mask with said face area, wherein said step of editing said face area is performed using said mask.

20. The method of claim 17, said editing comprising a step of editing the background of said face area.

21. The method of claim 14, wherein said editing comprises animating said associated digital image according to said predefined expression.

22. The method of claim 14, wherein said editing comprises adding a predefined voice tag according to said predefined expression.

23. The method of claim 14, further comprising a step between step c) and d) of verifying whether said matched user identifier being associated with a digital image, wherein if said verification failed, said edited digital image is a default digital image.
